(19) United States
(12) Patent Application Publication
(10) Pub. No.: US 2005/0249062 A1
(43) Pub. Date: Nov. 10, 2005

(54) Optical pickup

(75) Inventor: Tsuguhiro Abe, Chiba (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: SONY CORPORATION, Tokyo (JP)

(21) Appl. No.: 11/125,122

(22) Filed: May 10, 2005

(30) Foreign Application Priority Data
May 10, 2004 (JP) 2004-140464
Apr. 7, 2005 (JP) 2005-111290

(51) Int. Cl. G11B 7/00

(52) U.S. Cl. 369/44.32; 369/44.27; 369/112.01

(57) ABSTRACT

The present invention relates to a removal of a noise due to an interference between an emitted light from a light emitting element of laser beam for reading a signal from an optical disc and a return light from the optical disc. The present invention provides a pickup device for reading a signal from an optical disc, including a light emitting element that emits a laser beam irradiated on the optical disc, an objective lens that condenses the laser beam emitted from the light emitting element on a signal recording surface of the optical disc, a light-receiving element that receives a return light reflected on the signal surface of the optical disc, and a noise removing section removing the noise component generated by the interference between the emitted light and the return light, the noise removing section being arranged in an optical path having a route for the emitted light and the return light.

### CROSS REFERENCES TO RELATED APPLICATIONS

The present invention contains subject matter related to Japanese Patent Application JP 2004-140464, filed in the Japanese Patent Office on May 10, 2004, the entire contents of which being incorporated herein by reference.

### BACKGROUND OF THE INVENTION

1. Field of the Invention

The present invention relates to an optical pickup for recording and reproducing an information signal in an optical disc, and more particularly to an optical system of the optical pickup.

2. Description of Related Art

In an optical pickup device for recording or reproducing an optical recording medium, as shown in FIG. 1, many optical integrated elements so-called a laser coupler of the structure that a light emitting element and a light-receiving element are disposed in a hybrid manner, has been heretofore produced.

A laser coupler 100 includes, as shown in FIG. 1 and FIG. 2, a laser coupler chip 105 which mounts a laser diode 103 of a light emitting element and a microprism 104 on one silicon chip 102 having photodiodes 101a and 101b of a photodetector on a surface region, for example, in a flat package 106.

The laser diode 103 emits a laser beam having one or a plurality of wavelength bands at an intensity responsive to recording or reproducing of an information signal in response to a format of various optical discs inserted into an optical disc drive. The light emitted from a front surface of the laser diode 103 is reflected substantially perpendicularly at an oblique end face 104a of the microprism 104, and is guided, as shown in FIG. 2, to a signal recording surface of an optical disc 113 from an objective lens 112 through a transparent cover glass 110 on an upper surface of the flat package 106. On the other hand, the light reflected on the signal recording surface of the optical disc 113 is advanced at the same route between the optical disc 113 and the objective lens 112, and introduced into the flat package 106. The reflected light is transmitted through the oblique end face 104a of the microprism 104, and detected by the photodiodes 101a and 101b through the microprism 104.

In the optical pickup device using such a laser coupler 100, a part of the light reflected by the optical disc 113 is reflected at the oblique end face 104a of the microprism 104, reversed through a forward optical system, and thereby a return light incident on the laser diode 103 of a light emitting element is generated. Such a return light is incident on the laser diode 103, thereby interfered with a laser beam controlled to predetermined wavelength and intensity and outputted to become a laser noise component for giving an adverse influence to output characteristics of the laser diode 103. Therefore, various countermeasures are adopted.

For example, there are known a method of a light emitting pattern for superposing a high frequency of about several 100 MHz to several GHz on a current applied to the laser diode 103 rapidly repeating ON/OFF, a method of a so-called self-excited oscillation laser for improving a structure of a laser diode 103 itself to thereby rapidly repeat ON/OFF autonomously, etc.

[Patent Document 1:] Japanese Patent Application Laid-Open Publication No. 11-150323.

### SUMMARY OF THE INVENTION

However, in recent portable devices, such as a portable stereo device, a thin mobile notebook-sized personal computer, a portable game unit, etc., a demand for further reductions in size, thickness and power consumption of a device body is raised. Even in a disc drive used for such a portable device and an optical pickup device used for this disc drive, a response to further reductions in size and power consumption of the entire optical system is required, and a length of the optical path is required to be shortened.

With the demands for the reductions in the size and power consumption of such a portable device as well as for the shortening of the optical path length, the response using the superposition of high frequency or the self-excited oscillation laser cannot become a certain countermeasure against the above-mentioned demands.

More particularly, regarding the reduction in size of the optical pickup device, the shorter the route in which the light emitted from the laser diode is returned to the laser diode itself is, the stronger the interference arises due to the light in the laser diode. Accordingly, the length of the optical path is shortened, and hence a laser noise component is generated due to the interference between the emitted light and the return light in higher probability.

Regarding the low power consumption, a drive IC for superposing and a high frequency on a laser diode to drive the laser diode has a large power consumption, and hence this is contrary to the demand for the low power consumption. The self-excited oscillation laser has principally a higher operation current as compared with a so-called single-mode laser, and this also opposes to the demand for the low power consumption.

It is desirable to provide an optical pickup capable of maintaining preferable output characteristics of a laser diode by removing laser noise components while responding to requests for reductions in size and power consumption of an optical pickup device.

To solve the above-mentioned problems, the optical pickup according to the present invention comprises a light emitting element for emitting a laser beam to an optical disc, an objective lens for condensing a laser beam to a signal recording surface of the optical disc, a light-receiving element for receiving a return light reflected by the optical disc, and a noise component removing means for removing a noise component generated by introducing the return light to the light emitting element.

### BRIEF DESCRIPTION OF THE DRAWINGS

FIG. 1 is a perspective view showing an optical integrated element of a conventional optical pickup;

FIG. 2 is a side view showing an optical integrated element of the conventional optical pickup;

FIG. 3 is a perspective view showing an optical integrated element of an optical pickup to which the present invention is applied;

FIG. 4 is a perspective view showing the optical integrated element of the optical pickup to which the present invention is applied;

FIG. 5 is a side view showing an optical system of the optical pickup to which the present invention is applied;

FIGS. 6A and 6B are views showing an eye pattern of an RF signal of the optical pickup to which the present invention is applied;

FIG. 7 is a side view showing another optical system of the optical pickup to which the present invention is applied; and

FIG. 8 is a block diagram of a reproducer in which an optical pickup of the present invention is adopted.

### DETAILED DESCRIPTION OF THE PREFERRED EMBODIMENTS

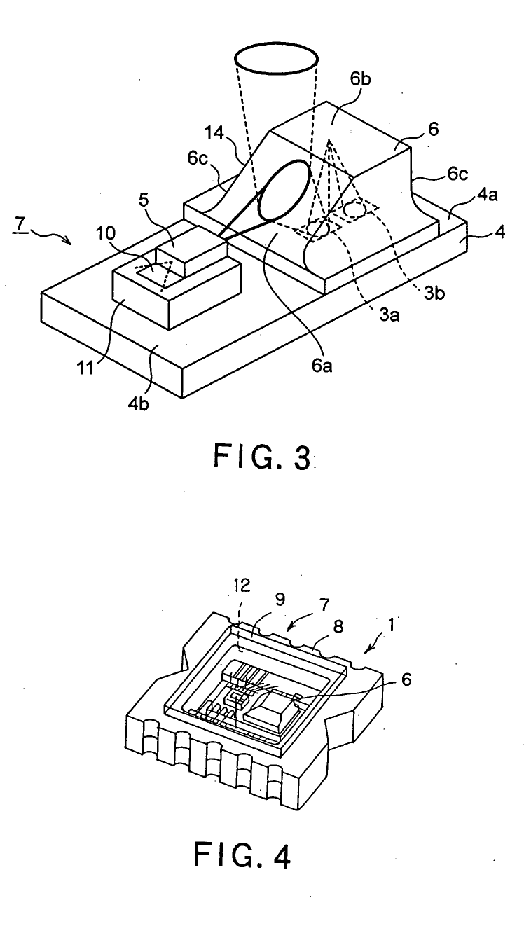

Hereinafter, an optical pickup to which the present invention is applied will be described in more detail with reference to the accompanying drawing. An optical system of the optical pickup according to the present invention uses an optical integrated element so-called a laser coupler of the structure that a light emitting element and a light-receiving element are disposed in a hybrid manner. This laser coupler 1 contains, as shown in FIG. 3 and FIG. 4, a laser coupler chip 7 having a laser diode 5 of light emission source and a microprism 6 mounted on one silicon chip 4 having photodetectors 3a and 3b for photodetecting provided on a surface region, for example, in a flat package 8.

The silicon chip 4 of the laser coupler chip 7 is formed in a substantially rectangular shape, and has photodetectors 3a and 3b formed by diffusion, etc. on a silicon wafer and formed by dicing the silicon wafer in a substantially rectangular shape. A microprism 6 is provided at one end 4a side of a longitudinal direction on this silicon chip 4, and a photodiode chip 11 carrying a laser diode 5 is provided at the other end 4b side.

The microprism 6 is provided at one end 4a side of a longitudinal direction of the silicon chip 4, and carried on the photodetectors 3a and 3b provided on the silicon chip 4. The microprism 6 has an oblique end face 6a formed to incline upward from the other end 4b side of the silicon chip 4 toward the one end 4a side. The microprism 6 has an upper surface 6b and a back surface 6c formed substantially flat. The oblique end face 6a of the microprism 6 is disposed oppositely to the laser diode 5 to be described later, and when a laser beam emitted from the laser diode 5 is irradiated, the laser beam is reflected substantially perpendicularly and irradiated to a signal recording surface of an optical disc 20. Also, when the reflected light from the optical disc 20 is irradiated, the oblique end face 6a refracts this reflected light, transmits the light through the microprism 6, and introduces the reflected light to the photodetectors 3a and 3b formed on a front surface of the silicon chip 4 under the microprism 6.

The laser diode 5 for irradiating a laser beam to the microprism 6 is disposed on the photodiode chip 11 having a PIN photodiode 10 provided on a front surface region, and is mounted at the other end 4b side of the silicon chip 4 through this photodiode chip 11. Further, the laser diode 5 is opposed to the oblique end face 6a of the microprism 6, as shown in FIG. 3, and the emitted laser beam is irradiated to the oblique end face 6a of the microprism 6. Incidentally, the PIN photodiode 10 provided in the photodiode chip 11 monitors the laser beam emitted from the rear surface of the laser diode 5 for the purpose of controlling an output of the laser diode 5.

The photodetectors 3a and 3b to which the reflected light from the signal recording surface of the optical disc 20 is irradiated are formed at one end 4a side of the silicon chip 4. The photodetectors 3a and 3b detect a signal for tracking controlling by a known three-beam method, etc., or for focus controlling by an astigmatic method, etc. with the irradiation of the reflected light from the optical disc 20. Incidentally, as the photodetectors 3a and 3b, various patterns are used in response to a reflected light detecting method.

The silicon chip 4 has a wire pad (not shown) for a bonding wire connected to a substrate of a flat package 8 for housing the laser coupler chip 7 near the photodiode chip 11.

The flat package 8 for housing the laser coupler chip 7 has, as shown in FIG. 4, a housing recess part 12 for housing the silicon chip 4 of the laser coupler chip 7. A mounting substrate for mounting the laser coupler chip 7 is provided in the housing recess part 12. The laser coupler chip 7 is mounted on the mounting substrate, and is connected to the wire pad through the bonding wire.

The flat package 8 for housing the laser coupler chip 7 is sealed by a ¼ wavelength plate 9. The ¼ wavelength plate 9 prevents an interference of both the emitted light and the return light due to a difference of polarized states of the emitted light and the return light even when the polarized state of the laser beam emitted from the laser diode 5 is changed, the light reflected by the signal recording surface of the optical disc 20 is thereby reflected to the laser side 5 side by the oblique end face 6a of the microprism 6 to generate the return light.

More particularly, the ¼ wavelength plate 9 emits a linearly polarized light emitted from the laser diode 5 as a circularly polarized light or an elliptically polarized light from the laser coupler chip 7 by sealing the housing recess part 12 of the flat package 8. Since such a laser beam is further polarized by the ¼ wavelength plate 9 when the laser beam is reflected on the signal recording surface of the optical disc 20 through another optical system of the optical pickup and again incident on the laser coupler chip 7, the reflected light has a different polarized state from the emitted light emitted from the laser diode 5 toward the microprism 6 by 90°. Therefore, if a part of the reflected light is reflected to the laser diode 5 side by the oblique end face 6a of the microprism 6, and this return light is incident on the laser diode 5, the return light is not interfered with the emitted light and generation of the laser noise component can be suppressed.

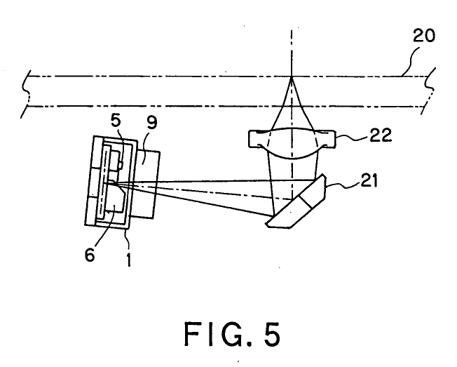

Such a laser coupler 1 is provided at a pickup base of the optical pickup device. Then, as shown in FIG. 5, a rising mirror 21 for rising the laser beam to the optical disc 20 side, and an objective lens 22 of the optical pickup device for condensing the laser beam to the signal recording surface of the optical disc 20 are disposed on the optical path of the laser beam incident on or emitted from the laser coupler 1. The laser coupler 1 is moved over the radial direction of the optical disc 20 inserted into the disc drive by moving this pickup base. When a reproduced signal from a controller of the disc drive is received, the laser coupler 1 emits the laser beam in the wavelength and the intensity of the band responsive to the type of the optical disc 20 inserted from the laser diode 5, and rises the laser beam in a perpendicular direction by the oblique end face 6a of the microprism 6. The laser beam rising in the perpendicular direction is circularly polarized and emitted by the ¼ wavelength plate 9, then emitted to the flat package 8, and condensed to the signal recording surface of the optical disc 20 via the objective lens 22 through the rising mirror 21.

The light reflected by the optical disc 20 is guided into the flat package 8 via the objective lens 22 and the rising mirror 21, and diffracted to the photodetectors 3a and 3b formed on the front surface region of the laser coupler chip 7 via the microprism 6. The photodetectors 3a and 3b receiving the reflected light detect a signal for a tracking control by a known three-beam method, etc. or focus control by an astigmatic method, etc.

Then, even if, of the light reflected by the optical disc 20, a light is reflected by the oblique end face 6a of the microprism 6 to the laser diode 5 side to generate a return light entering the laser diode 5, the light emitted from the laser coupler chip 7 is rotated at 90° in the polarized state by the ¼ wavelength plate 9, and the return light and the emitted light are different in the polarized states. Therefore, according to the optical pickup using the laser coupler 1, the interference between the return light and the emitted light is prevented, and the generation of the laser noise component can be suppressed. Thus, even when the length of the optical path of the optical system of the optical pickup is shortened, a noise component is not generated. It is not necessary to superpose a high frequency or to use a self-excited oscillation laser to remove the noise component, and hence shortening of the length of the optical path, a size reduction of the optical system and reduction in a power consumption can be realized.

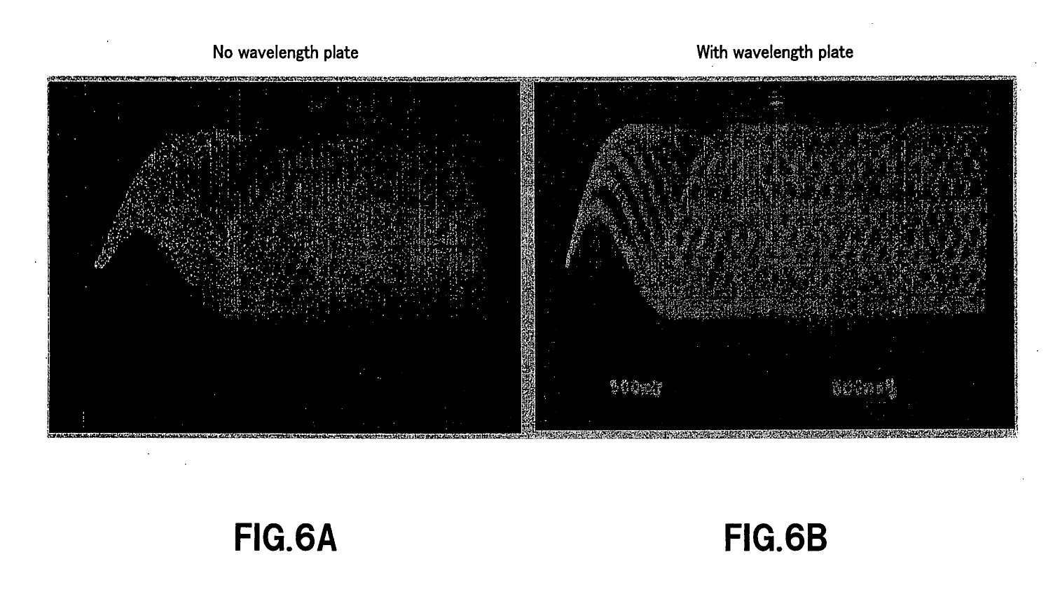

FIG. 6A shows an eye pattern of the RF signal detected by the optical pickup with no wavelength plate 9 and FIG. 6B shows an eye pattern of the RF signal detected by the optical pickup having a ¼ wavelength plate 9 according to the present invention. When the laser noise component due to the return light is generated, the laser noise component affects the output characteristics of the laser diode 5. Accordingly, a deterioration of the eye pattern of the RF signal is appeared. As shown in FIGS. 6A and 6B, with the optical pickup having the ¼ wavelength plate 9 according to the present invention, it is understood that the eye pattern of the RF signal is remarkably improved as compared with the optical pickup not having the ¼ wavelength plate 9. Therefore, with use of the optical pickup to which the present invention is applied, the detection of the RF signal can be stably performed without using the superposition of the high frequency, the self-excited oscillation laser, etc.

The optical pickup to which the present invention is applied is not limited to the one using the above-mentioned ¼ wavelength plate. For example, the optical pickup uses a liquid crystal element to rotate the polarized state of the laser beam. Incidentally, in the description given below, the same reference numeral is attached to the same member as the laser coupler 1, and its detailed description will be omitted.

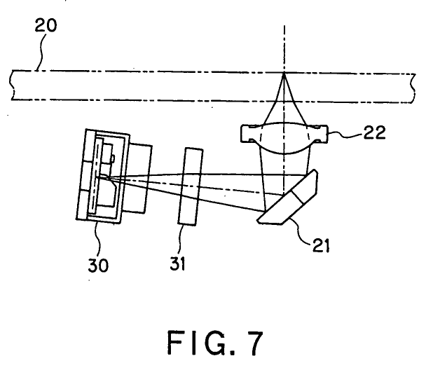

This laser coupler 30 does not have the ¼ wavelength plate 9 used in the above-mentioned laser coupler 1, but a transparent cover glass is sealed in the housing recess part 12 of the flat package 8. As shown in FIG. 7, a liquid crystal element 31, the rising mirror 21 for rising the laser beam to the optical disc 20 side, and an objective lens 22 of the optical pickup device for condensing the laser beam to the signal recording surface of the optical disc 20 are disposed on the optical path of the laser beam incident on or emitted from the laser coupler 30.

The liquid crystal element 31 prevents an interference between the emitted light and the return light from occurring due to a difference of the polarized states of the both lights even if the light reflected by the signal recording surface of the optical disc 20 is reflected to the laser diode 5 side by the oblique end face 6a of the microprism 6 to generate a return light by changing the polarized state of the laser beam emitted from the laser coupler chip 7. This liquid crystal element 31 is formed by sandwiching liquid crystal molecules between two glass substrates on which transparent electrodes are formed. When driving voltage is applied to the transparent electrodes, an orientation of the liquid crystal molecules is deviated according to an electric field by the applied voltage, and thereby, the polarized state of the laser beam transmitting the liquid crystal element 31 can be arbitrarily rotated.

Therefore, the optical pickup having the liquid crystal element 31 in accordance with the optical system can emit a linearly polarized light emitted by the laser coupler chip 7 as a circularly polarized light or elliptically polarized light. Such a laser beam is reflected on the signal recording surface of the optical disc 20 through other optical system, and again incident on the laser coupler chip 7 through the liquid crystal element 31. Since this reflected light is again polarized by the liquid crystal element 31, the reflected light is different from the light emitted from the laser diode 5 toward the microprism 6 in the polarized state. Therefore, even if a part of the reflected light is reflected to the laser diode 5 side by the oblique end face 6a of the microprism 6 and this return light is incident on the laser diode 5, the return light is not interfered with the emitted light and the generation of the laser noise component can be suppressed.

Incidentally, the optical pickup using the liquid crystal element 31 can regulate the polarized state of the laser beam by controlling the voltage applied to the transparent electrode provided on the glass substrate of the liquid crystal element 31 so as to become a polarized state for not interfering the emitted light with the return light in response to a jitter value degradation due to an environmental change, such as a temperature, etc., an accuracy fluctuation, etc. of the individual components of the optical system by the RF signal detected by the photodetectors 3a and 3b.

The liquid crystal element 31 as a noise removing section of the present invention is not limited in an arrangement to a position shown in FIG. 5, but may be disposed at any position in the optical path where the emitted light from the laser diode 5 and the return light reflected by the signal recording surface of the disc 2 and returned are interfered.

That is, the present invention can be applicable if the liquid crystal element 31 is within the space in which the emitted light path and the return light path are shared.

Since the wavelength and the intensity of the laser beam outputted from the laser diode 5 in response to a difference of disc formats are different in the optical pickup corresponding to a plurality of optical discs having different formats of a DVD, a CD, etc., optimum phase condition is set in response to such a difference, and the voltage applied to the liquid crystal element 31 can be controlled. Therefore, optimum laser noise component removal is performed in response to the type of the optical disc, and preferable RF signal detection can be conducted.

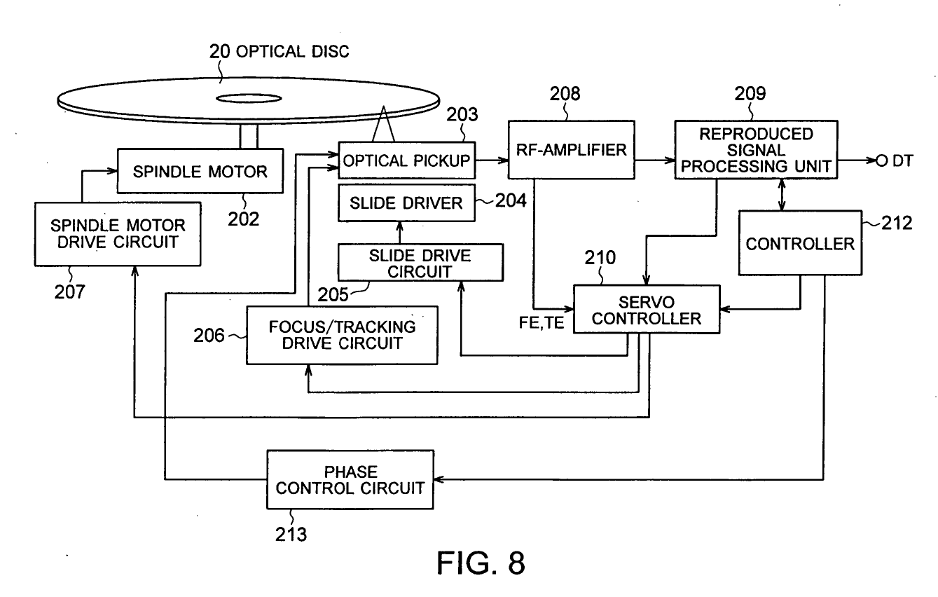

FIG. 8 is a view for explaining a structure of a reproducer for reproducing an optical disc by an optical pickup adopting the present invention. The optical pickup may sometimes be called an optical head.

The optical disc 20 is carried on a turntable (not shown), and rotatably driven at a constant linear velocity (CLV) or a constant angular velocity (CAV) by a spindle motor 202 at a reproducing time. Data recorded on the disc 1 in, for example, an embossed pit form is read by the pickup 203.

Here, as one example, the disc 1 is assumed to be a read only disc which records data in an embossed pit form, that is, a ROM type disc, but a write once type disc having a pit mark formed, for example, in a dye change pit form, a rewritable disc having a pit mark formed in a phase change pit form, a magnetic field pit form, etc. are considered. The reproducer of this example is considered as a reproducer for a recordable type disc.

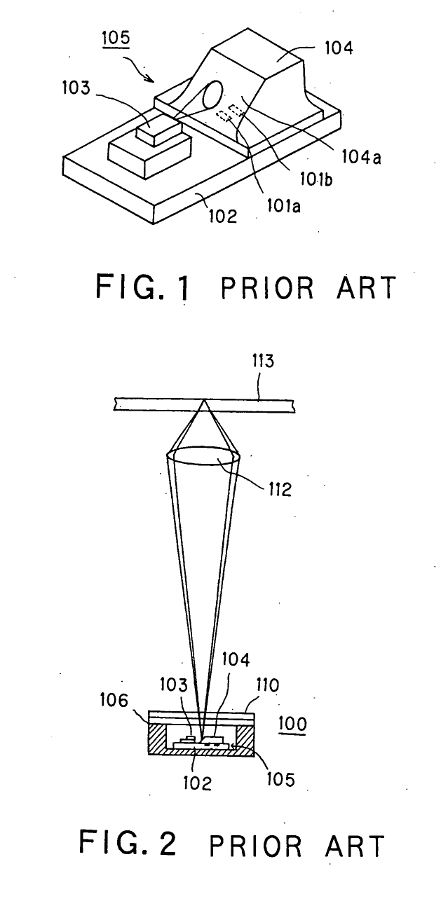

As described by referring to FIG. 1 so far, the laser diode 5 becoming a laser beam source, the photodetectors 3a, 3b for detecting the reflected light, the objective lens 22 as an output end of the laser beam, a biaxial mechanism (not shown) for movably holding the objective lens 22 in a tracking direction and a focusing direction, etc., are formed in the pickup 203.

Furthermore, the entire pickup 203 is radially movable of the disc by a slide driver 204.

Reflected beam information from the disc 20 is detected by the photodetctors 3a, 3b and converted to an electric signal in response to an amount of received light, which is supplied to an RF amplifier 208.

The RF amplifier 208 shown in FIG. 8 has a current-voltage converter for output currents from a plurality of the photodetetors 3a, 3b in the pickup 203, a matrix operational amplifier, etc., and generates a necessary signal by a matrix computing process. For example, the RF amplifier 208 generates the RF signal of the reproduced data, a focus error signal FE for servo controlling, a tracking error signal TE, etc.

The reproduced RF signal outputted from the RF amplifier 208 is supplied to a reproduced signal processing unit 209, and the focus error signal FE, the tracking error signal TE are supplied to a servo controller 210.

The reproduced RF signal obtained by the RF amplifier 208 is binarized, subjected to a PLL clock generation, a decoding process, a an error correction process, etc. in the reproduced signal processing unit 209. Reproduced data DT is obtained from the disc 20 by these processes, and outputted to a predetermined site or an external unit.

Further, a reproduced signal processing unit 209 extracts subcode information, address information from the information obtained by the decoding process and error correction process on the RF signal, and supplies the subcode information and address information to a controller 212.

The controller 212 is formed, for example, of a microcomputer, and controls the entire apparatus.

The servo controller 210 is formed, for example, of a DSP (Digital Signal Processor), generates various servo drive signals of focus, tracking, thread, spindle from the focus error signal FE, the tracking error signal TE from the RF amplifier 208, a spindle error signal SPE, etc. from a reproduced signal processing unit 209 or a controller 212, and executes a servo operation.

More particularly, a focus drive signal, a tracking drive signal are generated in response to the focus error signal FE, the tracking error signal TE, and supplied to a focus/tracking drive circuit 206. The focus/tracking drive circuit 206 drives a focus coil and a tracking coil of the biaxial mechanism in the pickup 203. Thus, a tracking servo loop and a focus servo loop of the pickup 203, the RF amplifier 28, the servo controller 210, the focus/tracking drive circuit 206 and the biaxial mechanism are formed.

The servo controller 210 further supplies a spindle drive signal generated in response to the spindle error signal to a spindle motor drive circuit 207. The spindle motor drive circuit 207 applies, for example, a three-phase drive signal to a spindle motor 202 in response to the spindle drive signal, and executes rotation of the spindle motor 202. The servo controller 210 generates the spindle drive signal in response to a spindle kick/brake control signal from the controller 212, and executes operations, such as activation, stopping, acceleration, deceleration, etc. of the spindle motor 202 by the spindle motor drive circuit 207.

The servo controller 210 generates a slide drive signal based on a slide error signal obtained, for example, as a low-pass component of the tracking error signal TE, an access execution control, etc. from the controller 212, and supplies the slide drive signal to a slide drive circuit 205. The slide drive circuit 205 drives a slide driver 204 in response to the slide drive signal. The slide driver 204 has, though not shown, a mechanism having a main shaft, a thread motor, a transmission gear, etc. for holding the pickup 203, the slide drive circuit 205 drives the slide driver 204 in response to the slide drive signal, thereby conducting a required slide movement of the pickup 203.

The controller 212 analyzes a reproduced signal obtained from a reproduced signal processing unit, and judges a type of the disc 20 carried on a turntable.

The controller 212 obtains optimum polarized rotary angle information stored in advance at each disc by the controller 212.

The controller 212 sends the optimum polarized rotary angle information for the disc 20 carried on the turntable to a phase control circuit 213 for controlling a voltage for giving a polarized rotary angle to the liquid crystal element 31 in the pickup 203.

The phase control circuit 213 generates a voltage for controlling the polarized rotary angle of the liquid crystal element 31 based on the sent polarized rotary angle information, and applies the voltage to the liquid crystal element 31.

The liquid crystal element 31 set to the optimum polarized rotary angle for the type of the disc carried on the turntable is arranged on an optical path by this operation, and a reproduced signal in which a noise component due to the interference between the reflected light from a disc surface and an emitted light from the laser diode 5 is removed is obtained.

It should be understood by those skilled in the art that various modifications, combinations, sub-combinations and alterations may occur depending on design requirements and other factors insofar as they are within the scope of the appended claims or the equivalents thereof.

1. A pickup device for reading a signal from an optical disc, comprising:
a light emitting element that emits a laser beam irradiated on the optical disc;
an objective lens that condenses the laser beam emitted from the light emitting element on a signal recording surface of the optical disc;
a light-receiving element that receives a return light reflected on the signal surface of the optical disc; and
noise removing means for removing the noise component generated by the interference between the emitted light and the return light, the noise removing means being arranged in an optical path having a route for the emitted light and the return light.

2. The pickup device according to claim 1, wherein the noise removing means has a ¼ wavelength plate.

3. The pickup device according to claim 1, wherein the noise removing means has a liquid crystal optical element.

4. The pickup device according to claim 3, wherein the noise removing means having a phase control means for setting a polarized rotary angle of the liquid crystal optical element.

5. A reproducer for reproducing a record signal recorded on an optical disc, comprising:
a light emitting element that emits a laser beam irradiated on the optical disc;
a focusing device that forcuses the laser beam emitted from the light emitting element on a signal recording surface of the optical disc;
a light-receiving element that receives a return light from the signal recording surface of the optical disc;
noise removing means for removing the noise generated by the interference between the emitted light and the return light, the noise removing means being arranged in an optical path having a route for the emitted light and the return light;
reproducing means for reproducing a record signal recorded on the optical disc received by the light-receiving element;
control means for judging a type of the optical disc based on the reproduced signal reproduced by the reproducing means and outputting a set value for setting an operation of the noise removing means based on the type of the optical disc;
noise removing control means for controlling noise removing characteristics of the noise removing means based on the set value outputted from the output means from the control means.

6. The reproducer according to claim 5, wherein the noise removing means has a liquid crystal optical element.

7. The reproducer according to claim 6, wherein the noise removing control means drives the liquid crystal optical element by a voltage for the liquid crystal optical element to become phase characteristics of a predetermined rotary polarized angle.

8. A pickup device for reading a signal from an optical disc, comprising:
a light emitting element that emits a laser beam irradiated on the optical disc;
an objective lens that condenses the laser beam emitted from the light emitting element on a signal recording surface of the optical disc;
a light-receiving element that receives a return light reflected on the signal surface of the optical disc; and
a noise removing section removing the noise component generated by the interference between the emitted light and the return light, the noise removing section being arranged in an optical path having a route for the emitted light and the return light.

9. A reproducer for reproducing a record signal recorded on an optical disc, comprising:
a light emitting element that emits a laser beam irradiated on the optical disc;
a focusing device that focuses the laser beam emitted from the light emitting element on a signal recording surface of the optical disc;
a light-receiving element that receives a return light from the signal recording surface of the optical disc;
a noise removing section removing the noise component generated by the interference between the emitted light and the return light, the noise removing section being arranged in an optical path having a route for the emitted light and the return light;
a reproducing section reproducing a record signal recorded on the optical disc received by the light-receiving element;
a controller judging a type of the optical disc based on the reproduced signal reproduced by the reproducing means and outputting a set value for setting an operation of the noise removing means based on the type of the optical disc;
a noise removing controller controlling noise removing characteristics of the noise removing section based on the set value outputted from the output means from the control means.
